(19) United States
(12) Patent Application Publication
(10) Pub. No.: US 2026/0029185 A1
(43) Pub. Date: Jan. 29, 2026

(54) STORAGE CABINET COMPRISING A DEVICE FOR TREATING THE INTERIOR AIR

(71) Applicant: Miele & Cie. KG, Guetersloh (DE)

(72) Inventors: Marco WIECHERT, Soest (DE); Stefan SCHMELTER, Guetersloh (DE); Jan LAUE, Guetersloh (DE)

(21) Appl. No.: 18/997,096

(22) PCT Filed: Jul. 25, 2023
(86) PCT No.: PCT/EP2023/070596

§ 371 Date: Jan. 20, 2025

(30) Foreign Application Priority Data
Aug. 4, 2022 (DE) 10 2022 119 529.5

(51) Int. Cl. F25D 17/04; B01D 46/10; B01D 46/84

(52) U.S. Cl. CPC F25D 17/042; B01D 46/10; B01D 46/84; B01D 2253/102; F25D 2317/041

(57) ABSTRACT

Disclosed herein is a storage cabinet, such as a refrigerator, climatic chamber, wine storage cabinet, or freezer. The storage cabinet includes at least one thermally insulated interior for receiving stored goods, said interior having an access opening which can be closed by means of a door. The storage cabinet includes a cooling unit which can be activated for predefined cooling capacities in order to cool the air in the interior. The storage cabinet includes a device for treating the interior air, the device including a flow channel having a filter element attached therein and a flow generator for conveying the air through the filter element, the flow channel including at least one inlet opening and at least one outlet opening for connection to the interior. The filter element includes a filter medium made of material that can be regenerated.

### CROSS-REFERENCE TO RELATED APPLICATION(S)

This application is a national phase of PCT/EP2023/070596 filed on Jul. 25, 2023 that claims priority to German Patent Application No. DE 10 2022 119 529.5 filed on Aug. 4, 2022, the contents of both of which are incorporated fully herein by reference.

### BACKGROUND

The odor of some foods is sometimes perceived as unpleasant. In order to eliminate odors in the interior of a refrigerator, odor filters are known which are inserted into the interior or against which an air flow flows for circulation. U.S. Pat. No. 7,988,771 B2 discloses a cooling device in which the interior air is circulated in a rear flow channel by means of a fan. This distributes the cold air to all storage regions. A filter element is inserted into the flow channel, against which filter element the air flows or through which filter element some of the air in the flow channel flows.

Overall, filters have a limited service life and usually need to be replaced every 3 to 12 months because the air flow rate decreases and the filtering effect deteriorates over time.

### BRIEF SUMMARY

The invention relates to a storage cabinet, such as a refrigerator, climatic chamber, wine storage cabinet, or freezer, said storage cabinet including at least one thermally insulated interior for receiving stored goods, said interior having an access opening which can be closed by means of a door. The storage cabinet also includes a cooling unit which can be activated for predefined cooling capacities in order to cool the air in the interior;-a device for treating the interior air, the device comprising a flow channel having a filter element attached therein and a flow generator for conveying the air through the filter element, the flow channel comprising at least one inlet opening and at least one outlet opening for connection to the interior.

The object is therefore to provide a storage cabinet which improves the filtering of the interior air in a simple manner.

Accordingly, this object is achieved at least by a storage cabinet having the features of claim 1 and claim 15 and by a filter element according to claim 7. Advantageous features and further embodiments can be found in the respective dependent claims.

### BRIEF DESCRIPTION OF THE DRAWINGS

The drawings are merely exemplary schematics, in which:

FIG. 1 shows a storage cabinet with a view into the interior;

FIG. 2 shows an example of a sketched sectional representation of the storage cabinet;

FIGS. 3 and 4 each show the air channel in the region of the filter holder in a schematic sectional representation for different embodiments; and

FIG. 5 shows an example of the process of regenerating the filter element or filter medium.

### DESCRIPTION

The advantages that may be achieved by the disclosed storage cabinet are that, in addition to keeping stored goods such as fresh food fresh, odor impairment in the interior is also eliminated, reduced or avoided in a simple manner either permanently or over a long period of time. For this purpose, the filter element comprises a filter medium made of material that can be regenerated. This means that the used filter element or the filter medium can be removed from the storage cabinet after a predefined period of use and reactivated using a regeneration action. Regeneration cleans the filter medium or returns it to its functionally new state so that it can be used again for a predefined operating time. A used filter element therefore does not need to be disposed of, which avoids waste for an operating time of several years.

In an advantageous embodiment, the filter element is sealingly attached in the flow channel. As a result, all of the circulated air is conveyed through the filter element or the filter medium contained therein. This results in rapid and intensive filtering of the interior air in the inner container. In an expedient embodiment, the flow generator can be activated at intervals so that the air is filtered only if it is required due to use of the storage cabinet.

In an expedient embodiment, the filter element is arranged in the region of the inlet opening or close to the inlet opening of the flow channel. In this region, sufficient installation space can be provided to receive the filter element. The air distribution channels are expediently located behind the rear wall of the inner container so that there is usually no space to accommodate a filter element here.

In a further, advantageous embodiment, the flow channel comprises at least one access opening for inserting the filter element into the flow channel and for removing the filter element from the flow channel, wherein the access opening is arranged on the flow channel in the region of the inlet opening or between the inlet opening and the outlet opening. This makes the access opening easily accessible.

In an expedient development, the access opening is closed by means of a cover, wherein the cover is mounted on the access opening in a removable or pivotable manner. A cover panel of the inlet opening can also be used as a cover if the receiving space for the filter element is provided in the inlet opening. If the access opening is located in the central channel region, it is advantageous for the cover to sealingly close the access opening to the flow channel in order to prevent air loss due to leakage.

In an overall advantageous embodiment, the filter element is designed as a drawer which comprises a cover plate that closes the access opening when inserted. A filter element of this kind is easy to handle because it is guided linearly in the receiving space. This ensures positioning at the intended location in the receiving space.

In an overall advantageous embodiment of the storage cabinet, the storage cabinet comprises a filter element, as described below.

The disclosed storage cabinet further relates to a filter element that is shaped and designed for use in a flow channel in a storage cabinet, such as a refrigerator or freezer or drinks storage cabinet, as described above.

In an advantageous embodiment, the filter element comprises a carrier, the filter medium being received or secured in the carrier. The carrier may be designed as a frame, as a frame having a grid, or as a cassette. The frame is made of a solid material and provides the dimensional stability of the filter element. The filter medium may be soft and flexible and is stabilized or held in shape by the carrier. The filter medium may also consist of a rigid block made of solid material, for example sintered granules or filter granules baked with a binding agent, the filter medium being stably positioned in the carrier and protected from damage.

For the design of the filter element as a drawer, the carrier can be shaped to assume the function of a drawer, the filter medium being inserted therein.

In an overall expedient embodiment, the filter medium and the carrier consist of heat-resistant material, preferably heat-resistant up to a value in the range of greater than 150° C. to 300° C., preferably greater than 180° C. to 250° C. This is necessary if the regeneration of the filter medium takes place by heat input for a predefined time.

In an advantageous development, the filter medium can be regenerated by heat input at a temperature value in the range of from 150° C. to 300° C., preferably from 180° C. to 250° C., for a period in the range of from 20 minutes to 100 minutes, preferably from 40 minutes to 70 minutes, particularly preferably a period of time of about 60 minutes. In this process, substances bound in the filter medium are thermally removed or thermally destroyed or removed due to pyrolysis. After regeneration, the filter element is ready for use again for the predefined period.

In an overall expedient embodiment, the filter medium comprises multi-layer fiber material which is coated with activated carbon.

In another embodiment, the filter medium comprises granules consisting of or containing activated carbon. For this purpose, the carrier must be designed, for example, as a cassette having fine-pore grid frames so that the granules remain in the carrier.

In a further embodiment, the filter medium comprises open-pore foam consisting of or containing activated carbon.

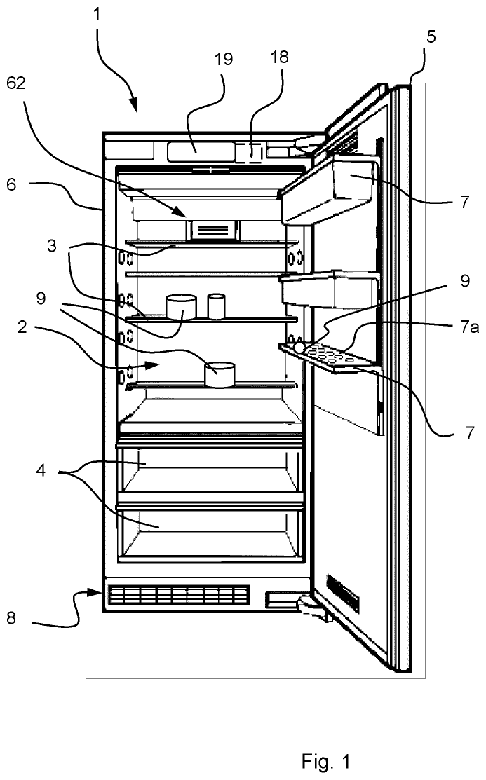

FIG. 1 shows a storage cabinet 1 which has an open door 5 and the interior 2 of which is visible. In this example, the storage cabinet 1 is a refrigerator comprising a housing 6 in the interior 2 of which there are a plurality of shelves 3, inserted one above the other, and a plurality of storage compartments 4, inserted one above the other and functioning as drawers, for receiving goods 9 to be stored. Inside the housing 6, the refrigerator 1 comprises a cooling unit 8 for cooling the interior 2. A plurality of storage compartments 7 are attached on the inside of the door 5, one compartment 7a being designed as a plate having recesses for securely storing eggs. The front side 10 of the drawer-like storage compartment 4 is transparent in this illustration, but it may be made opaque so that it is only possible to see inside when it has been pulled out. The storage cabinet 1 further comprises a device 40 for treating and circulating the air in the interior 2 and a controller 18 which controls or activates and deactivates the cooling unit 8 and the air treatment device 40.

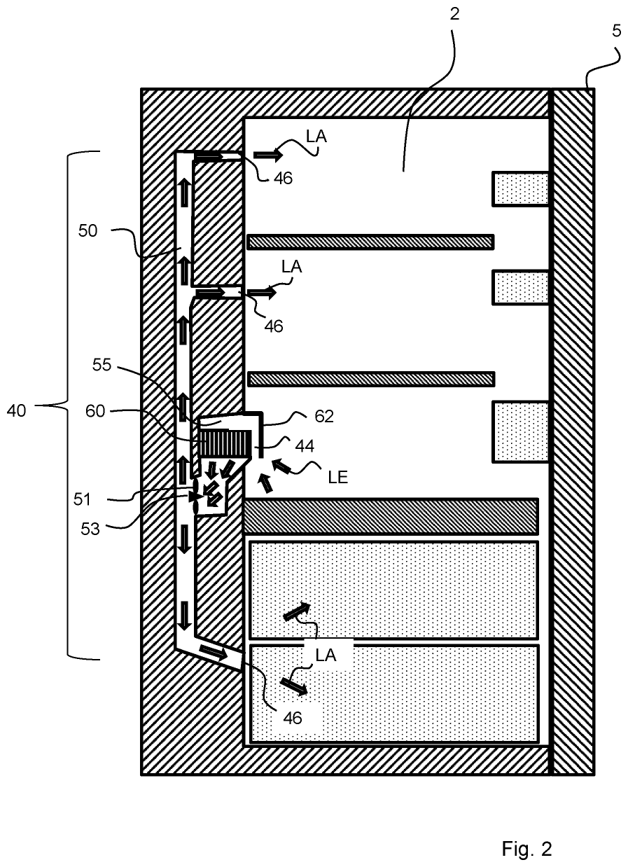

In the embodiment shown in FIG. 2, the storage cabinet 1 is shown in a sketched sectional representation. A channel 50 which extends from the air inlet 44 to a plurality of air outlets 46 is formed outside the inner container 2. Within the channel 50, the filter element 60 with the filter medium 61 arranged therein is arranged in the receiving space 55. The fan 51 is driven by means of the fan motor 53 and is used to generate an air flow and thereby draw the air LE through the inlet opening 44 into the channel 50 and to convey it through the filter element 60 and the filter medium 61 and out of the channel 50 via the air outlet 46. The discharged, cleaned air LA is then conveyed back into the interior 2 of the storage cabinet 1.

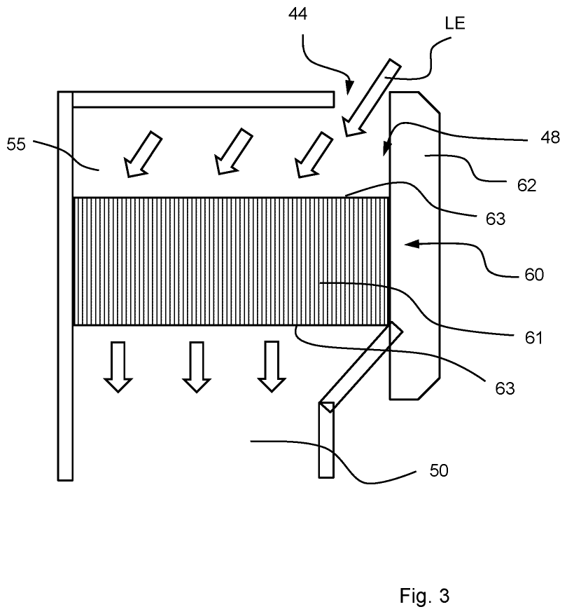

FIG. 3 shows the channel 50 in the region of the receiving space 55 with an inserted filter element 60 in a schematic sectional representation. The cover plate 62 closes the access opening 48 at least in part so that the inlet opening 44 remains open as a gap in this example. After removing the cover plate 62, the filter element 60 can be taken out of the receiving space 55. In this embodiment, the filter element may be designed as a drawer so that the cover plate 62 is firmly connected to the filter element. When the cover plate 62 is taken out of the operating position, the filter element 60 is taken along with it. Guide means may be present in the receiving space 55 in order to provide a secure fit for the filter element 60. The filter element 60 is designed as a flat, planar block and is placed horizontally in the receiving space 55. The filter element 60 preferably comprises a casing or cassette designed as a carrier 63, within which the filter medium 61 is inserted. The carrier 63 is used to stabilize the shape of the filter element 60, and the filter medium 61 comprises the active material which provides the filtering effect.

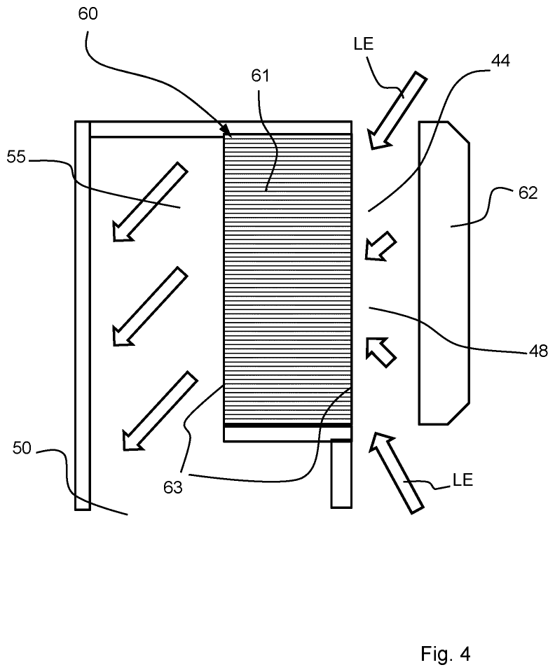

FIG. 4 shows the channel 50 in the region of the receiving space 55 with an inserted filter element 60 in a schematic sectional representation in a different embodiment. The cover plate 62 closes the access opening 48 at least in part so that, in this example, the inlet opening 44 remains open as a gap, preferably a circumferential gap around the receiving space 55. After removing the cover plate 62, the filter element 60 can be taken out of the receiving space 55. Guide means may be present in the receiving space 55 in order to provide a secure fit for the filter element 60. The filter element 60 is designed as a flat, planar block and is placed vertically in the receiving space 55. The filter element 60 preferably comprises a casing or cassette designed as a carrier 63, within which the filter medium 61 is inserted. The carrier 63 is used to stabilize the shape of the filter element 60, and the filter medium 61 comprises the active material which provides the filtering effect.

The filter element 60 can also be inserted into the receiving space 55 at an angle or slant. The specified positioning results from the installation space that can be made available in the storage cabinet 1.

For all embodiments or sketched examples, the filter element 60 is inserted into the receiving space 55 in such a way that it rests in a sealing manner in the flow channel 50. The filter medium is preferably designed in such a way that a maximum flow loss of 10% occurs during operation of the flow generator 51, 52. This is achieved accordingly by appropriate dimensioning of the pore size or mesh size of the filter medium 61 and the thickness thereof.

Overall, all direction and position information relates to the proper set-up position of the storage cabinet 1.

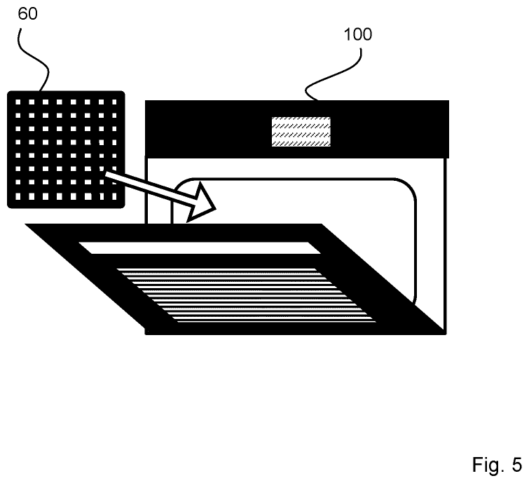

FIG. 5 schematically shows the actions for regenerating the filter element 60 or filter medium 61. After removing the filter element 60 from the storage cabinet 1 (FIGS. 1, 2), the part 60 or only the filter medium 61, if it has been taken out of a carrier 63, is placed in a hot chamber, for example an oven 100. In this oven 100, the filter element 60 or filter medium 61 is heated for a predefined time at a predefined temperature of a value as mentioned above. After this regeneration has been completed, the filter element 60 with the filter medium 61 contained therein or the filter medium 61 is removed from the oven 100 and reinserted into the receiving space 55 of the flow channel 50 in the storage cabinet 1.

1. A storage cabinet comprising:
at least one thermally insulated interior for receiving stored goods, said interior having an access opening which can be closed by means of a door;
a cooling unit which can be activated for predefined cooling capacities in order to cool air in the interior; and
a device for treating the air in the interior, the device comprising a flow channel having a filter element attached therein and a flow generator for conveying the air through the filter element, the flow channel comprising at least one inlet opening and at least one outlet opening for connection to the interior,
wherein
the filter element comprises a filter medium made of material that can be regenerated.

2. The storage cabinet according to claim 1,
wherein the filter element is sealingly attached in the flow channel.

3. The storage cabinet according to claim 1,
wherein the filter element is arranged in a region of the inlet opening or close to the inlet opening of the flow channel.

4. The storage cabinet according to claim 1, wherein the flow channel comprises an access opening for inserting the filter element into the flow channel and for removing the filter element from the flow channel, wherein the access opening is arranged on the flow channel in a region of the inlet opening or between the inlet opening and the outlet opening.

5. The storage cabinet according to claim 4, wherein the access opening is closed by means of a cover, wherein the cover is mounted on the access opening in a removable or pivotable manner.

6. The storage cabinet according to claim 3, wherein the filter element is designed as a drawer which comprises a cover plate that closes the access opening when inserted.

7. A filter element shaped and designed for use in a flow channel in a storage cabinet, the filter element comprising a filter medium made of material that can be regenerated.

8. The filter element according to claim 7,
wherein the filter element comprises a carrier and the filter medium is received or secured in the carrier.

9. The filter element according to claim 8, wherein the filter medium and the carrier consist of heat-resistant material.

10. The filter element according to claim 7, wherein the filter medium can be regenerated by heat input at a temperature from 150° C. to 300° C. for a period from 20 minutes to 100 minutes.

11. The filter element according to claim 7, wherein the filter medium comprises multi-layer fiber material which is coated with activated carbon.

12. The filter element according to claim 7, wherein the filter medium comprises granules consisting of or containing activated carbon.

13. The filter element according to claim 7, wherein the filter medium comprises open-pore foam consisting of or containing activated carbon.

14. The filter element according to claim 7, wherein the filter medium comprises granules consisting of or containing activated carbon, which are sintered or are formed into a solid block by means of a binding agent.

15. The storage cabinet according to claim 1, the storage cabinet further comprising a filter element comprising:
a filter medium made of material that can be regenerated; and
a carrier configured to receive or secure the filter medium.

16. The storage cabinet of claim 1, wherein the storage cabinet comprises at least one of a refrigerator, a climatic chamber, a wine storage cabinet, or a freezer.

17. The storage cabinet of claim 9, wherein the heat-resistant material is heat-resistant up to at least 150° C.

18. The storage cabinet of claim 9, wherein the heat-resistant material is heat-resistant up to at least 250° C.
